(19) United States
(12) Patent Application Publication
(10) Pub. No.: US 2020/0276989 A1
(43) Pub. Date: Sep. 3, 2020

(54) COMPUTER ASSISTED OR AUTONOMOUS DRIVING (CA/AD) TOWING VEHICLES AND TRAILERS

(71) Applicant: Intel Corporation, Santa Clara, CA (US)

(72) Inventors: Jason GARCIA, Chandler, AZ (US); Tomer RIDER, Naahryia Z (IL); Wenlong YANG, Shanghai (CN)

(21) Appl. No.: 16/649,579

(22) PCT Filed: Dec. 20, 2017
(86) PCT No.: PCT/CN2017/117521

§ 371 Date: Mar. 20, 2020

(51) Int. Cl. B60W 60/00; G01S 19/42; B60W 30/06; G08G 1/14

(52) U.S. Cl. CPC B60W 60/0025; G01S 19/42; B60W 30/06; G08G 1/141; B60W 2420/54; B60W 2300/125; B60W 2300/14; B60W 2420/52; B60W 2420/42; B60W 2300/123

(57) ABSTRACT

Embodiments include apparatuses, methods, and systems for computer assisted or autonomous driving (CA/AD). An apparatus may include a trailer data collection unit and an automation level determination unit coupled with the trailer data collection unit. The trailer data collection unit may collect, from a trailer coupled with a CA/AD towing vehicle, trailer configuration data, including sensor configuration data for sensors disposed on the trailer. The automation level determination unit may determine a combined level of driving automation for the CA/AD towing vehicle and the trailer, based at least in part on the trailer configuration data, wherein the CA/AD towing vehicle alone has an initial level of driving automation. An apparatus for CA/AD may include a sensor configuration unit, a trailer configuration unit, and a communication interface coupled with the sensor configuration unit and the trailer configuration unit. Other embodiments may also be described and claimed.

### FIELD

Embodiments of the present disclosure relate generally to the technical fields of vehicles, and more particularly to computer assisted or autonomous driving vehicles, and computer assisted or autonomous driving towing vehicles and trailers.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A computer assisted or autonomous driving (CA/AD) vehicle, also referred to as an autonomous car, a driverless car, a self-driving car, a robotic car, or a unmanned ground vehicle, may be a vehicle that is capable of sensing its environment and navigating without human input for certain functions. CA/AD vehicles are gaining momentum and popularity. Currently, CA/AD vehicles mostly provide dynamic and personalized transportation services from a source to a destination. Some vehicles, e.g., boats, an all-terrain vehicle, or trailers, may provide services more than just mere transportation, e.g., outdoor sports and recreational activities. However, CA/AD vehicles for trailers and corresponding towing vehicles have not been addressed much in the current technology.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example apparatus for computer assisted or autonomous driving (CA/AD), where the apparatus includes a CA/AD towing vehicle coupled with a trailer, in accordance with various embodiments.

FIG. 2 illustrates an example process to be performed by a CA/AD towing vehicle, in accordance with various embodiments.

FIG. 3 illustrates an example process to be performed by a CA/AD towing vehicle to couple a trailer, in accordance with various embodiments.

FIGS. 4(a)-4(c) illustrate example operations to place one or more sensors on a trailer or a CA/AD towing vehicle to eliminate a blind spot for the trailer or the CA/AD towing vehicle, in accordance with various embodiments.

FIG. 5 illustrates example operations to determine a cornering path to be followed by a CA/AD towing vehicle coupled with a trailer to turn a corner, in accordance with various embodiments.

FIG. 6 illustrates an example computer device suitable for use to practice various aspects of the present disclosure, in accordance with various embodiments.

FIG. 7 illustrates a storage medium having instructions for practicing methods described with references to FIGS. 1-6, in accordance with various embodiments.

FIG. 8 illustrates an environment in which various embodiments described with references to FIGS. 1-7 may be practiced.

### DETAILED DESCRIPTION

Computer assisted or autonomous driving (CA/AD) vehicles are gaining momentum and popularity. Society of automotive engineers (SAE) has defined autonomy levels for CA/AD vehicles, including level 0 to level 5, to indicate various levels of automated systems and features in a CA/AD vehicle. However, current CA/AD vehicles consider mostly transportation functions rather than other kinds of functions, e.g., trailers for outdoor sports and recreational activities. Some prototype CA/AD semi-truck vehicles may have some trailering for highway driving with sensor suites integrated only in the vehicle. However, prototype CA/AD semi-truck vehicles may be limited to highway but insufficient to enable other use cases. In addition, current towing vehicle to trailer connectivity may only support power and control for braking, refrigeration, lighting, but does not support sensors or trailer based computer-assisted operations.

In embodiments, an apparatus for CA/AD may include a trailer data collection unit and an automation level determination unit coupled with the trailer data collection unit. The trailer data collection unit may collect, from a trailer coupled with a CA/AD towing vehicle, trailer configuration data, including sensor configuration data for sensors disposed on the trailer. The automation level determination unit may determine a combined level of driving automation for the CA/AD towing vehicle and the trailer, based at least in part on the trailer configuration data, wherein the CA/AD towing vehicle alone has an initial level of driving automation.

In embodiments, an apparatus for computer assisted or autonomous driving may include a sensor configuration unit, a trailer configuration unit, and a communication interface coupled with the sensor configuration unit and the trailer configuration unit. The sensor configuration unit may collect sensor configuration data for one or more sensors disposed on a trailer. The trailer configuration unit may collect trailer configuration data. The communication interface may transmit the sensor configuration data and the trailer configuration data to a CA/AD towing vehicle.

In embodiments, one or more non-transitory computer-readable media may include instructions that cause a CA/AD system in a CA/AD towing vehicle, in response to execution of the instructions by the CA/AD system, to: collect, from a trailer, sensor configuration data for one or more sensors disposed on the trailer, and trailer configuration data; and determine a combined level of driving automation for the CA/AD towing vehicle coupled to the trailer, wherein the CA/AD towing vehicle alone has an initial level of driving automation.

In the description to follow, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used hereinafter, including the claims, the term “unit,” “engine,” “module,” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a general purpose processing unit (GPU), a single-core processor, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications.

As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

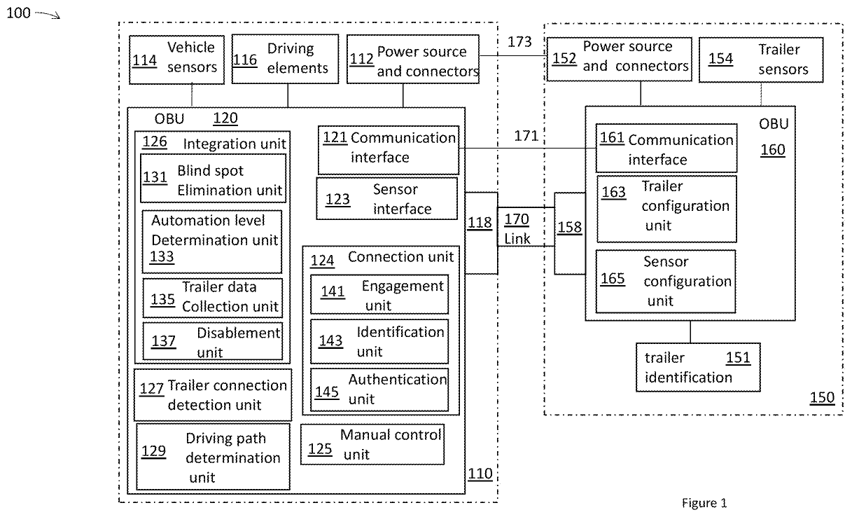

FIG. 1 illustrates an example apparatus 100 for CA/AD, where the apparatus 100 may include a CA/AD towing vehicle 110 coupled with a trailer 150, in accordance with various embodiments. For clarity, features of the apparatus 100, the CA/AD towing vehicle 110, and the trailer 150 may be described below as an example for understanding an apparatus for CA/AD, a CA/AD towing vehicle, and a trailer. It is to be understood that there may be more or fewer components included in the apparatus 100, the CA/AD towing vehicle 110, and the trailer 150. Further, it is to be understood that one or more of the devices and components within the apparatus 100, the CA/AD towing vehicle 110, and the trailer 150 may include additional and/or varying features from the description below, and may include any devices and components that one having ordinary skill in the art would consider and/or refer to as the devices and components of an apparatus for CA/AD, a CA/AD towing vehicle, and a trailer.

In embodiments, the apparatus 100 for CA/AD may include the CA/AD towing vehicle 110 coupled to the trailer 150. The CA/AD towing vehicle 110 may be coupled to the trailer 150 through a link 170, which may be a mechanical link, to connect a coupler 118 of the CA/AD towing vehicle 110 and a coupler 158 of the trailer 150. In addition, the CA/AD towing vehicle 110 may communicate with the trailer 150 via a communication technology 171 through a communication interface 121 of the CA/AD towing vehicle 110 and a communication interface 161 of the trailer 150. Furthermore, the CA/AD towing vehicle 110 may be coupled to the trailer 150 via a power source connection 173 through one or more power source and connectors 112 of the CA/AD towing vehicle 110 and one or more power source and connectors 152 of the trailer 150.

In embodiments, the CA/AD towing vehicle 110 may include a vehicle onboard unit (OBU) 120, the coupler 118, one or more sensors 114 disposed on the CA/AD towing vehicle 110, one or more driving elements 116, and one or more power source and connectors 112. The OBU 120 may include the communication interface 121, a sensor interface 123, a manual control unit 125, a driving path determination unit 129, a trailer connection detection unit 127, a connection unit 124, and an integration unit 126. In addition, the connection unit 124 may include an engagement unit 141, an identification unit 143, and an authentication unit 145. The integration unit 126 may include a blind spot elimination unit 131, an automation level determination unit 133, a trailer data collection unit 135, and a disablement unit 137. The trailer 150 may include the coupler 158, one or more power source and connectors 152, one or more sensors 154 disposed on the trailer 150, a trailer identification unit 151, and an OBU 160. The OBU 160 may include a sensor configuration unit 165, a trailer configuration unit 163, and the communication interface 161.

In embodiments, the CA/AD towing vehicle 110 may be a selected one of a commercial truck, a light duty car, a sport utility vehicle (SUV), a light vehicle, a heavy duty vehicle, a pickup truck, a van, a car, a motorcycle, or any other towing vehicle. The trailer 150 may include a selected one of a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

In embodiments, the coupler 118 of the CA/AD towing vehicle 110, or the coupler 158 of the trailer 150, may include a selected one of a ball and socket coupler, a gooseneck trailer jack, a straight coupler, an a-frame coupler, or an adjustable coupler. The communication technology 171 through the communication interface 121 of the CA/AD towing vehicle 110 and the communication interface 161 of the trailer 150 may include a wireless technology selected from dedicated short range communications (DSRC) technology, Bluetooth technology, wireless fidelity (WiFi) technology, wireless local network (WLAN), cellular wireless network technology, wireless universal serial bus (WUSB) technology, or short range radio technology. The communication interface 121 or the communication interface 161 may receive various data packets and/or data streams, navigation signaling/data (e.g., global navigation satellite system (GNSS), global positioning system (GPS), etc.), and/or the like. In embodiments, the communication interface 121 or the communication interface 161 may also include, or operate in conjunction with communications circuitry and/or input/output (I/O) interface circuitry in order to obtain the data for the various sources. For example, the communication interface 121 or the communication interface 161 may include an interface an input/output (I/O) or bus interface, such as a I² bus, an Integrated Drive Electronic (IDE) bus, a Serial Advanced Technology Attachment (SATA) bus, a Peripheral Component Interconnect (PCI) bus, a Universal Serial Bus (USB), a Near Field Communication (NFC) interface, a Bluetooth® interface, WiFi, and so forth.

In embodiments, the sensor interface 123 may receive, from one or more sensors 114 disposed on the CA/AD towing vehicle 110, sensor data. For example, the sensor data may include one or more selected from radar data, ultrasonic sensor data, video sensor data, camera data, light detection and ranging (LiDAR) data, or global positioning system (GPS) data. In embodiments, the sensor data may include identification information of the trailer 150, as indicated by the trailer identification unit 151.

In embodiments, the connection unit 124 may include components that manage the functions for making a connection between the CA/AD towing vehicle 110 and the trailer 150. For example, the connection unit 124 may include the identification unit 143 to identify the trailer 150 based on the sensor data received by the sensor interface 123, and collected by the one or more sensors 114. For example, the sensor data may include identification information of the trailer 150, as indicated by the trailer identification unit 151. The connection unit 124 may further include the authentication unit 145 to authenticate, via the communication technology 171, that the trailer 150 is authorized to be towed by the CA/AD towing vehicle 110. The connection unit 124 may also include the engagement unit 141 to couple the coupler 118 of the CA/AD towing vehicle 110 with the coupler 158 of the trailer 150. In addition, the engagement unit 141 may further disengage the trailer 150 from the CA/AD towing vehicle 110 through disconnection of the coupler 118 of the CA/AD towing vehicle 110 from the coupler 158 of the trailer 150.

In embodiments, the trailer connection detection unit 127 may detect that the trailer 150 coupled to the CA/AD towing vehicle 110 is compatible with the CA/AD towing vehicle 110. If the trailer 150 is not compatible with the CA/AD towing vehicle 110, the manual control unit 125 may be operational and the CA/AD features of the towing vehicle 110 may be turned off for the combined vehicle including the CA/AD towing vehicle 110 and the trailer 150. The manual control unit 125 may also be operational when the CA/AD features of the towing vehicle 110 may be disabled for other reasons, e.g., malfunction. In some embodiments, the trailer connection detection unit 127 may determine the compatibility based on the trailer configuration data collected by the trailer data collection unit 135.

In embodiments, the integration unit 126 may include the trailer data collection unit 135 to collect from the trailer 150, trailer configuration data collected by the trailer configuration unit 163. The trailer configuration data may include sensor configuration data, collected by the sensor configuration unit 165 for the one or more sensors 154 disposed on the trailer 150. The sensor configuration data may include a number of sensors disposed on the trailer, and further include sensor types, sensor locations on the trailer, manufacturers of the sensors, resolutions of the sensors, ranges of the sensors, or data collection rates of the sensors. The sensor configuration data may enable sensors from any third party, instead of the manufacturer of the CA/AD towing vehicle 110 or the trailer 150 to be used, and information about such third party sensors may be integrated into the functions of the CA/AD towing vehicle 110 or the trailer 150.

In embodiments, the trailer configuration data may further include a trailer length, a trailer width, a trailer height, a trailer wheel or axle distance measured from one end of the trailer, a trailer wheel or axle distance measured from another end of the trailer, a location of a coupler of the trailer, a trailer weight, a trailer shape, a trailer type, a trailer manufacturer, or a trailer capacity. A commercial fleet may commonly include a range of CA/AD towing vehicles and a range of trailers. It may also be common for a commercial fleet to mix and match the specific CA/AD towing vehicle to a specific trailer. Similarly, an individual owner may own multiple trailers that they interchange as needed. The trailer configuration data may enable a CA/AD towing vehicle to tow a variety of trailers.

In embodiments, the integration unit 126 may further include the automation level determination unit 133 to determine a combined level of driving automation for the CA/AD towing vehicle 110 and the trailer 150, based at least in part on the trailer configuration data from the trailer data collection unit 135. For example, the CA/AD towing vehicle 110 alone may have an initial level of driving automation. After the CA/AD towing vehicle 110 is combined with the trailer 150 to tow the trailer 150, the combined vehicle including the CA/AD towing vehicle 110 and the trailer 150 may have a combined level of driving automation less than the initial level of driving automation for the CA/AD towing vehicle 110. For example, a trailer equipped only ultrasonic and video sensors may not eligible for level 3, level 4, or level 5 of driving automation, due to the lack of longer ranged sensors (LiDAR/RADAR). If the CA/AD towing vehicle 110 may have an initial level of driving automation of level 3 or higher, the combined vehicle including the CA/AD towing vehicle 110 and the trailer 150 may have a combined level of driving automation less than level 3. In addition, other factors of sensors such as resolution, range, data collection rate, etc. of the sensors may also play a role in determining a combined level of driving automation for the combined vehicle including the CA/AD towing vehicle 110 and the trailer 150.

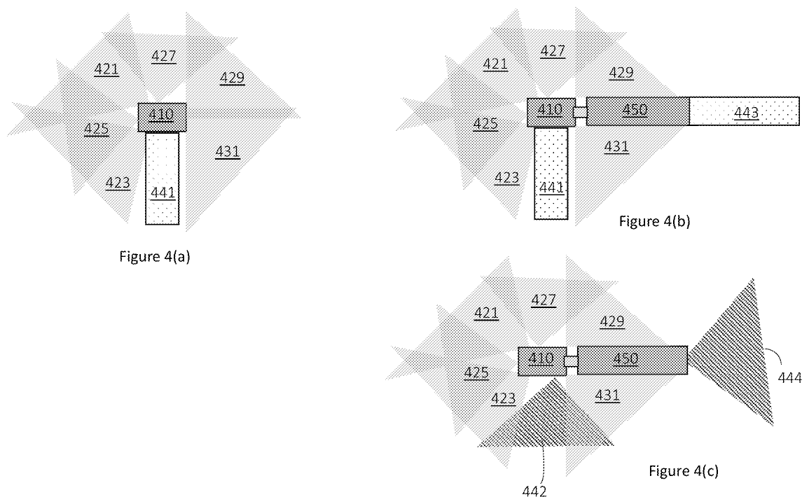

In embodiments, the integration unit 126 may further include the disablement unit 137 to disable one or more automation driving features available to the initial level of driving automation but not to the combined level of driving automation. In addition, the integration unit 126 may further include the blind spot elimination unit 131 to provide information to place one or more sensors on the trailer 150 or the CA/AD towing vehicle 110 to eliminate a blind spot for the trailer 150 or the CA/AD towing vehicle 110, as shown in more details in FIG. 4.

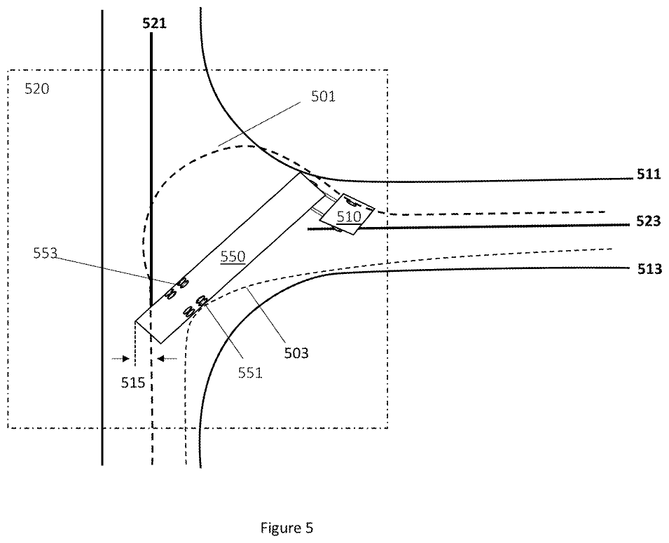

In embodiments, the driving path determination unit 129 may determine various driving paths for the combined vehicle including the CA/AD towing vehicle 110 and the trailer 150. The combined vehicle including the CA/AD towing vehicle 110 and the trailer 150 may have a different driving path than the CA/AD towing vehicle 110 alone. For example, when turning a corner, the driving path determination unit 129 may determine a cornering path to be followed by the CA/AD towing vehicle 110 coupled with the trailer 150 to turn a corner, based at least in part on the trailer configuration data, configuration data for the CA/AD towing vehicle, and physical configuration of the corner. More details of such a corner path determination may be shown in FIG. 5. In addition, the driving path determination unit 129 may select a parking spot from a parking location with multiple parking spots, and determine a parking path to park the CA/AD towing vehicle 110 coupled with the trailer 150 into the selected parking spot.

In embodiments, the trailer 150 may include the one or more sensors 154 disposed on the trailer 150, a trailer identification unit 151, and an OBU 160. The OBU 160 may include the sensor configuration unit 165, the trailer configuration unit 163, and the communication interface 161. The sensor configuration unit 165 may collect sensor configuration data for the one or more sensors 154. The trailer configuration unit 163 may collect trailer configuration data. The communication interface 161 may transmit the sensor configuration data and the trailer configuration data to the CA/AD towing vehicle 110. In addition, the trailer identification unit 151 may include identification information of the trailer 150, which may be indicated by a license plate, a graphic identification, or other identifications such as RFID numbers.

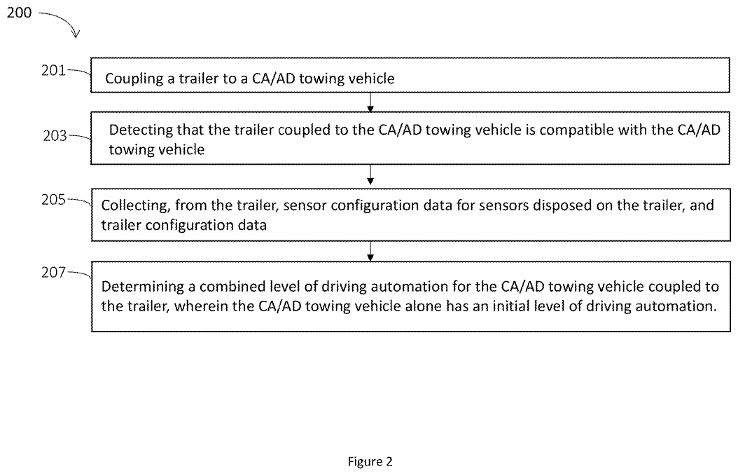

FIG. 2 illustrates an example process 200 to be performed by a CA/AD towing vehicle, in accordance with various embodiments. In embodiments, the process 200 may be performed by the CA/AD towing vehicle 110 in FIG. 1.

The process 200 may start at an interaction 201. During the interaction 201, a trailer may be coupled to a CA/AD towing vehicle. For example, at the interaction 201, the trailer 150 may be coupled to the CA/AD towing vehicle 110. When the trailer 150 is coupled to the CA/AD towing vehicle 110, the link 170 to connect the coupler 118 and the coupler 158, the communication technology 171 to communicate through the communication interface 121 the communication interface 161, and the power source connection 173 through one or more power source and connectors 112 and one or more power source and connectors 152, may be established.

During an interaction 203, operations may be performed to detect that the trailer coupled to the CA/AD towing vehicle is compatible with the CA/AD towing vehicle. For example, at the interaction 203, the trailer connection detection unit 127 of the CA/AD towing vehicle 110 may perform operations to detect that the trailer 150 coupled to the CA/AD towing vehicle 110 is compatible with the CA/AD towing vehicle 110.

During an interaction 205, operations may be performed to collect, from the trailer, sensor configuration data for sensors disposed on the trailer, and trailer configuration data. For example, at the interaction 205, the trailer data collection unit 135 may collect, from the trailer 150, sensor configuration data for sensors disposed on the trailer, and trailer configuration data.

During an interaction 207, operations may be performed to determine a combined level of driving automation for the CA/AD towing vehicle coupled to the trailer, where the CA/AD towing vehicle alone has an initial level of driving automation. For example, at the interaction 207, the automation level determination unit 133 may perform operations to determine a combined level of driving automation for the CA/AD towing vehicle 110 coupled to the trailer 150, where the CA/AD towing vehicle 110 alone has an initial level of driving automation.

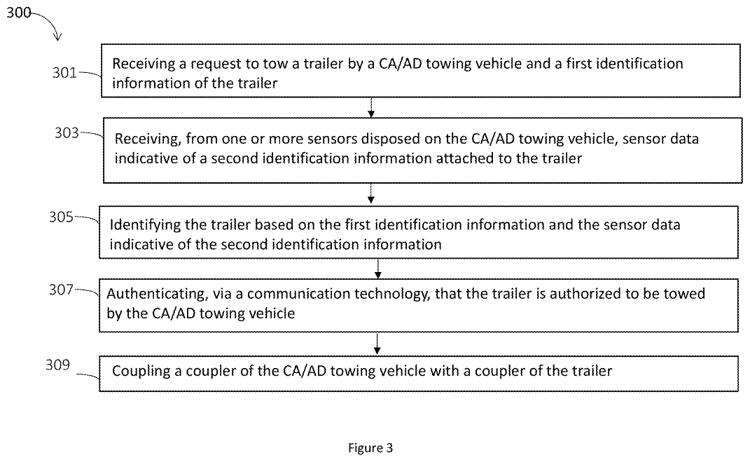

FIG. 3 illustrates an example process 300 to be performed by a CA/AD towing vehicle to couple a trailer, in accordance with various embodiments. In embodiments, the process 300 may be a process performed by the CA/AD towing vehicle 110 in FIG. 1.

The process 300 may start at an interaction 301. During the interaction 301, a request may be received to tow a trailer by a CA/AD towing vehicle, where the request may be received together with a first identification information of the trailer. For example, a request to tow the trailer 150 and a first identification information of the trailer 150 may be received by the CA/AD towing vehicle 110.

During an interaction 303, sensor data indicative of a second identification information attached to the trailer may be received from one or more sensors disposed on the CA/AD towing vehicle. For example, at the interaction 303, sensor data indicative of a second identification information attached to the trailer 150, which may be contained in the trailer identification unit 151, may be received from the one or more sensors 114 disposed on the CA/AD towing vehicle 110.

During an interaction 305, the trailer may be identified based on the first identification information and the sensor data indicative of the second identification information. For example, at the interaction 305, the trailer 150 may be identified based on the first identification information received together with the request, and the sensor data received from the one or more sensors 114 indicative of the second identification information contained in the trailer identification unit 151. For example, the first identification information received together with the request to tow the trailer 150 may be a license number of the trailer 150. The trailer identification unit 151 may be a license plate. The second identification information contained in the trailer identification unit 151 may be a photo of a license plate received from the one or more sensors 114 disposed on the CA/AD towing vehicle 110.

During an interaction 307, the trailer may be authenticated, via a communication technology, to be authorized to be towed by the CA/AD towing vehicle. For example, at the interaction 307, the trailer 150 may be authenticated, via the communication technology 171, to be authorized to be towed by the CA/AD towing vehicle 110. The authentication may be performed by the authentication unit 145 of the CA/AD towing vehicle 110.

During an interaction 309, a coupler of the CA/AD towing vehicle may be coupled with a coupler of the trailer. For example, at the interaction 309, the coupler 118 of the CA/AD towing vehicle 110 may be coupled with the coupler 158 of the trailer 150. The operations to couple the coupler 118 and the coupler 158 may be performed by the engagement unit 141.

FIGS. 4(a)-4(c) illustrate example operations to place one or more sensors on a trailer 450 or a CA/AD towing vehicle 410 to eliminate a blind spot for the trailer 450 or the CA/AD towing vehicle 410, in accordance with various embodiments. In embodiments, the CA/AD towing vehicle 410 or the trailer 450 may be example of the CA/AD towing vehicle 110 or the trailer 150 in FIG. 1.

In embodiments, as shown in FIG. 4(a), there may be a number of sensors disposed on the CA/AD towing vehicle 410. For example, the CA/AD towing vehicle 410 may include a sensor with a field of view (FOV) 421, a sensor with a FOV 423, a sensor with a FOV 425, a sensor with a FOV 427, a sensor with a FOV 429, and a sensor with a FOV 431. The FOV 421, the FOV 423, and the FOV 425 may cover the front side of the CA/AD towing vehicle 410. The FOV 427 may cover one side of the CA/AD towing vehicle 410. The FOV 429 and the FOV 431 may cover the back of the CA/AD towing vehicle 410. The CA/AD towing vehicle 410 may have a blind spot 441, which is not covered by the combined area of the FOV 421, the FOV 423, the FOV 425, the FOV 429, and the FOV 431. The FOV 421, the FOV 423, the FOV 425, the FOV 429, and the FOV 431 may be shown as a triangular shape, but they may be of any other shapes.

In embodiments, as shown in FIG. 4(b), when the trailer 450 is coupled to the CA/AD towing vehicle 410, the trailer 450 may block a part of the FOV 429 and the FOV 431, and create an additional blind spot 443.

In embodiments, as shown in FIG. 4(c), a sensor with a FOV 442 may be installed on the side of the CA/AD towing vehicle 410 to eliminate the blind spot 441, and a sensor with a FOV 444 may be installed on the trailer 450 to eliminate the blind spot 443. The location to install the sensor with the FOV 442 and the sensor with the FOV 444 may be determined by a blind spot elimination unit, similar to the blind spot elimination unit 131, of the CA/AD towing vehicle 410.

FIG. 5 illustrates example operations to determine a cornering path to be followed by a CA/AD towing vehicle 510 coupled with a trailer 550 to turn a corner, in accordance with various embodiments. In embodiments, the CA/AD towing vehicle 510 or the trailer 550 may be example of the CA/AD towing vehicle 110 or the trailer 150 in FIG. 1.

In embodiments, the CA/AD towing vehicle 510 may be coupled to a trailer 550. The combined vehicle may make a turn at an intersection 520 formed by an initial path line 521 and an end path line 523 orthogonal to the initial path line 521. The intersection 520 may have an inner curb 513, and an outer curb 511. The trailer may have inner tire 551, and outer tire 553. The inner tire 551 may follow an inner tire path 503, and the outer tire 511 may follow an outer tire path 501. In making the turn, the trailer 550 may have an overhang sweet distance 515, measured from the initial path line 521. The CA/AD towing vehicle 510 may have a driving path determination unit, which may be similar to the driving path determination unit 129 of the CA/AD towing vehicle 110, may determine the inner tire path 503 and the outer tire path 501 to be within the inner curb 513 and the outer curb 511. The driving path determination unit may determine the inner tire path 503 and the outer tire path 501 based on trailer configuration data of the trailer 550, which may be collected by a trailer configuration unit similar to the trailer configuration unit 163. The CA/AD towing vehicle 510 may collect the trailer configuration data of the trailer 550 through a trailer data collection unit, which may be similar to the trailer data collection unit 135. Afterwards, the driving path determination unit may determine the inner tire path 503 and the outer tire 511.

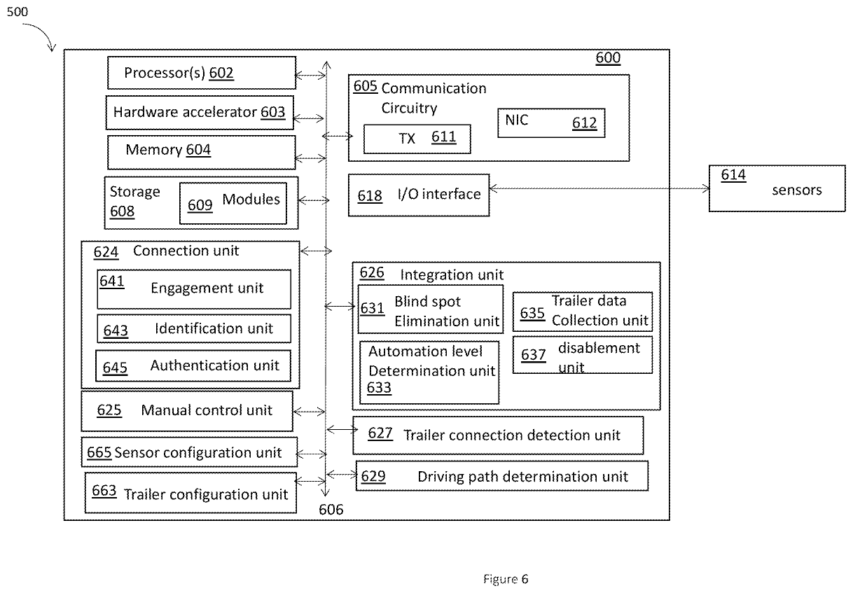

FIG. 6 illustrates an example computer device 600 that may be suitable as a device to practice selected aspects of the present disclosure. The device 600 may be used to implement functions of the apparatus 100, the OBU 120, or the OBU 160, as shown in FIG. 1. As shown, the device 600 may include one or more processors 602, each having one or more processor cores, or and optionally, a hardware accelerator 603 (which may be an ASIC or a FPGA). In alternate embodiments, the hardware accelerator 603 may be part of processor 602, or integrated together on a SOC. Additionally, the device 600 may include a memory 604, which may be any one of a number of known persistent storage medium, and a data storage circuitry 608 including modules 609. In addition, the 600 may include an input/output interface 618, coupled to one or more sensors 614. Furthermore, the device 600 may include communication circuitry 605 including a transceiver (Tx) 611, and network interface controller (NIC) 612. The elements may be coupled to each other via system bus 606, which may represent one or more buses. In the case of multiple buses, they may be bridged by one or more bus bridges (not shown).

In addition, the device 600 may include a sensor configuration unit 665, a trailer configuration unit 663, a manual control unit 625, a driving path determination unit 629, a trailer connection detection unit 627, a connection unit 624, and an integration unit 626. In addition, the connection unit 624 may include an engagement unit 641, an identification unit 643, and an authentication unit 645. The integration unit 626 may include a blind spot elimination unit 631, an automation level determination unit 633, a trailer data collection unit 635, and a disablement unit 637. In embodiments, the manual control unit 625, the driving path determination unit 629, the trailer connection detection unit 627, the connection unit 624, the integration unit 626, the engagement unit 641, the identification unit 643, the authentication unit 645, the blind spot elimination unit 631, the automation level determination unit 633, the trailer data collection unit 635, the disablement unit 637, the sensor configuration unit 665, and the trailer configuration unit 663, may be similar to the corresponding the manual control unit 125, the driving path determination unit 129, the trailer connection detection unit 127, the connection unit 124, the integration unit 126, the engagement unit 141, the identification unit 143, the authentication unit 145, the blind spot elimination unit 131, the automation level determination unit 133, the trailer data collection unit 135, the disablement unit 137, the sensor configuration unit 165, the trailer configuration unit 163, respectively, as shown in FIG. 1.

In embodiments, the processor(s) 602 (also referred to as “processor circuitry 602”) may be one or more processing elements configured to perform basic arithmetical, logical, and input/output operations by carrying out instructions. Processor circuitry 602 may be implemented as a standalone system/device/package or as part of an existing system/device/package. The processor circuitry 602 may be one or more microprocessors, one or more single-core processors, one or more multi-core processors, one or more multithreaded processors, one or more GPUs, one or more ultra-low voltage processors, one or more embedded processors, one or more DSPs, one or more FPDs (hardware accelerators) such as FPGAs, structured ASICs, programmable SoCs (PSoCs), etc., and/or other processor or processing/controlling circuit. The processor circuitry 602 may be a part of a SoC in which the processor circuitry 602 and other components discussed herein are formed into a single IC or a single package. As examples, the processor circuitry 602 may include one or more Intel Pentium®, Core®, Xeon®, Atom®, or Core M® processor(s); Advanced Micro Devices (AMD) Accelerated Processing Units (APUs), Epyc®, or Ryzen® processors; Apple Inc. A series, S series, W series, etc. processor(s); Qualcomm Snapdragon® processor(s); Samsung Exynos® processor(s); and/or the like.

In embodiments, the processor circuitry 602 may include a sensor hub, which may act as a coprocessor by processing data obtained from the one or more sensors 614. The sensor hub may include circuitry configured to integrate data obtained from each of the one or more sensors 614 by performing arithmetical, logical, and input/output operations. In embodiments, the sensor hub may capable of timestamping obtained sensor data, providing sensor data to the processor circuitry 602 in response to a query for such data, buffering sensor data, continuously streaming sensor data to the processor circuitry 602 including independent streams for each sensor of the one or more sensors 614, reporting sensor data based upon predefined thresholds or conditions/triggers, and/or other like data processing functions.

In embodiments, the memory 604 (also referred to as “memory circuitry 604” or the like) may be circuitry configured to store data or logic for operating the computer device 600. The memory circuitry 604 may include number of memory devices may be used to provide for a given amount of system memory. As examples, the memory circuitry 604 can be any suitable type, number and/or combination of volatile memory devices (e.g., random access memory (RAM), dynamic RAM (DRAM), static RAM (SAM), etc.) and/or non-volatile memory devices (e.g., read-only memory (ROM), erasable programmable read-only memory (EPROM), electrically erasable programmable read-only memory (EEPROM), flash memory, antifuses, etc.) that may be configured in any suitable implementation as are known. In various implementations, individual memory devices may be formed of any number of different package types, such as single die package (SDP), dual die package (DDP) or quad die package (Q17P), dual inline memory modules (DIMMs) such as microDIMMs or MiniDIMMs, and/or any other like memory devices. To provide for persistent storage of information such as data, applications, operating systems and so forth, the memory circuitry 604 may include one or more mass-storage devices, such as a solid state disk drive (SSDD); flash memory cards, such as SD cards, microSD cards, xD picture cards, and the like, and USB flash drives; on-die memory or registers associated with the processor circuitry 602 (for example, in low power implementations); a micro hard disk drive (HDD); three dimensional cross-point (3D XPOINT) memories from Intel® and Micron®, etc.

Where FPDs are used, the processor circuitry 602 and memory circuitry 604 (and/or data storage circuitry 608) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry 602 to implement various logic functions. The memory cells may include any combination of various levels of memory/storage including, but not limited to, EPROM, EEPROM, flash memory, SRAM, anti-fuses, etc.

In embodiments, the data storage circuitry 608 (also referred to as “storage circuitry 608” or the like), with shared or respective controllers, may provide for persistent storage of information such as modules 609, operating systems, etc. The data storage circuitry 608 may be implemented as solid state drives (SSDs); solid state disk drive (SSDD); serial AT attachment (SATA) storage devices (e.g., SATA SSDs); flash drives; flash memory cards, such as SD cards, microSD cards, xD picture cards, and the like, and USB flash drives; three-dimensional cross-point (3D Xpoint) memory devices; on-die memory or registers associated with the processor circuitry 602; hard disk drives (HDDs); micro HDDs; resistance change memories; phase change memories; holographic memories; or chemical memories; among others. As shown, the data storage circuitry 608 is included in the computer device 600; however, in other embodiments, the data storage circuitry 608 may be implemented as one or more devices separated from the other elements of computer device 600.

In some embodiments, the data storage circuitry 608 may include an operating system (OS) (not shown), which may be a general purpose operating system or an operating system specifically written for and tailored to the computer device 600. The OS may include one or more drivers, libraries, and/or application programming interfaces (APIs), which provide program code and/or software components for modules 609 and/or control system configurations to control and/or obtain/process data from the one or more sensors 614.

The modules 609 may be software modules/components used to perform various functions of the computer device 600 and/or to carry out functions of the example embodiments discussed herein. In embodiments where the processor circuitry 602 and memory circuitry 604 includes hardware accelerators (e.g., FPGA cells, the hardware accelerator 603) as well as processor cores, the hardware accelerators (e.g., the FPGA cells) may be pre-configured (e.g., with appropriate bit streams, logic blocks/fabric, etc.) with the logic to perform some functions of the embodiments herein (in lieu of employment of programming instructions to be executed by the processor core(s)). For example, the modules 609 may comprise logic for the corresponding entities discussed with regard to the manual control unit 625, the driving path determination unit 629, the trailer connection detection unit 627, the connection unit 624, the integration unit 626, the engagement unit 641, the identification unit 643, the authentication unit 645, the blind spot elimination unit 631, the automation level determination unit 633, the trailer data collection unit 635, the disablement unit 637, the sensor configuration unit 665, the trailer configuration unit 663.

The components of computer device 600 may communicate with one another over the bus 606. The bus 606 may include any number of technologies, such as a Local Interconnect Network (LIN); industry standard architecture (ISA); extended ISA (EISA); PCI; PCI extended (PCIx); PCIe; an Inter-Integrated Circuit (I2C) bus; a Parallel Small Computer System Interface (SPI) bus; Common Application Programming Interface (CAPI); point to point interfaces; a power bus; a proprietary bus, for example, Intel® Ultra Path Interface (UPI), Intel® Accelerator Link (IAL), or some other proprietary bus used in a SoC based interface; or any number of other technologies. In some embodiments, the bus 606 may be a controller area network (CAN) bus system, a Time-Trigger Protocol (TTP) system, or a FlexRay system, which may allow various devices (e.g., the one or more sensors 614, etc.) to communicate with one another using messages or frames.

The communications circuitry 605 may include circuitry for communicating with a wireless network or wired network. For example, the communication circuitry 605 may include transceiver (Tx) 611 and network interface controller (NIC) 612. Communications circuitry 605 may include one or more processors (e.g., baseband processors, modems, etc.) that are dedicated to a particular wireless communication protocol.

NIC 612 may be included to provide a wired communication link to a network and/or other devices. The wired communication may provide an Ethernet connection, an Ethernet-over-USB, and/or the like, or may be based on other types of networks, such as DeviceNet, ControlNet, Data Highway+, PROFIBUS, or PROFINET, among many others. An additional NIC 612 may be included to allow connect to a second network (not shown) or other devices, for example, a first NIC 612 providing communications to the network 150 over Ethernet, and a second NIC 612 providing communications to other devices over another type of network, such as a personal area network (PAN) including a personal computer (PC) device. In some embodiments, the various components of the device 600, such as the one or more sensors 614, etc. may be connected to the processor(s) 602 via the NIC 612 as discussed above rather than via the I/O circuitry 618 as discussed infra.

The Tx 611 may include one or more radios to wirelessly communicate with a network and/or other devices. The Tx 611 may include hardware devices that enable communication with wired networks and/or other devices using modulated electromagnetic radiation through a solid or non-solid medium. Such hardware devices may include switches, filters, amplifiers, antenna elements, and the like to facilitate the communications over the air (OTA) by generating or otherwise producing radio waves to transmit data to one or more other devices, and converting received signals into usable information, such as digital data, which may be provided to one or more other components of computer device 600. In some embodiments, the various components of the device 600, such as the one or more sensors 614, etc. may be connected to the device 600 via the Tx 611 as discussed above rather than via the I/O circuitry 618 as discussed infra. In one example, the one or more sensors 614 may be coupled with device 600 via a short range communication protocol.

The Tx611 may include one or multiple radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), and Fifth Generation (5G) New Radio (NR). It can be noted that radios compatible with any number of other fixed, mobile, or satellite communication technologies and standards may be selected. These may include, for example, any Cellular Wide Area radio communication technology, which may include e.g. a 5G communication systems, a Global System for Mobile Communications (GSM) radio communication technology, a General Packet Radio Service (GPRS) radio communication technology, or an Enhanced Data Rates for GSM Evolution (EDGE) radio communication technology.

Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated. Implementations, components, and details of the aforementioned protocols may be those known in the art and are omitted herein for the sake of brevity.

The input/output (I/O) interface 618 may include circuitry, such as an external expansion bus (e.g., Universal Serial Bus (USB), FireWire, Thunderbolt, PCI/PCIe/PCIx, etc.), used to connect computer device 600 with external components/devices, such as one or more sensors 614, etc. I/O interface circuitry 618 may include any suitable interface controllers and connectors to interconnect one or more of the processor circuitry 602, memory circuitry 604, data storage circuitry 608, communication circuitry 605, and the other components of computer device 600. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., bus 606), ports, slots, jumpers, interconnect modules, receptacles, modular connectors, etc. The I/O circuitry 618 may couple the device 600 with the one or more sensors 614, etc. via a wired connection, such as using USB, FireWire, Thunderbolt, RCA, a video graphics array (VGA), a digital visual interface (DVI) and/or mini-DVI, a high-definition multimedia interface (HDMI), an S-Video, and/or the like.

The one or more sensors 614 may be any device configured to detect events or environmental changes, convert the detected events into electrical signals and/or digital data, and transmit/send the signals/data to the computer device 600. Some of the one or more sensors 614 may be sensors used for providing computer-generated sensory inputs. Some of the one or more sensors 614 may be sensors used for motion and/or object detection. Examples of such one or more sensors 614 may include, inter alia, charged-coupled devices (CCD), Complementary metal-oxide-semiconductor (CMOS) active pixel sensors (APS), lens-less image capture devices/cameras, thermographic (infrared) cameras, Light Imaging Detection And Ranging (LIDAR) systems, and/or the like. In some implementations, the one or more sensors 614 may include a lens-less image capture mechanism comprising an array of aperture elements, wherein light passing through the array of aperture elements define the pixels of an image. In embodiments, the motion detection one or more sensors 614 may be coupled with or associated with light generating devices, for example, one or more infrared projectors to project a grid of infrared light onto a scene, where an infrared camera may record reflected infrared light to compute depth information.

Some of the one or more sensors 614 may be used for position and/or orientation detection, ambient/environmental condition detection, and the like. Examples of such one or more sensors 614 may include, inter alia, microelectromechanical systems (MEMS) with piezoelectric, piezoresistive and/or capacitive components, which may be used to determine environmental conditions or location information related to the computer device 600. In embodiments, the MEMS may include 3-axis accelerometers, 3-axis gyroscopes, and/or magnetometers. In some embodiments, the one or more sensors 614 may also include one or more gravimeters, altimeters, barometers, proximity sensors (e.g., infrared radiation detector(s) and the like), depth sensors, ambient light sensors, thermal sensors (thermometers), ultrasonic transceivers, and/or the like.

Each of these elements, e.g., one or more processors 602, the hardware accelerator 603, the memory 604, the data storage circuitry 608 including the modules 609, the input/output interface 618, the one or more sensors 614, the communication circuitry 605 including the Tx 611, and the NIC 612, and the system bus 606, may perform its conventional functions known in the art. In addition, they may be employed to store and host execution of programming instructions implementing the operations associated with operations to be performed by an apparatus for computer assisted or autonomous driving, as described in connection with FIGS. 1-5, and/or other functions that provides the capability of the embodiments described in the current disclosure. The various elements may be implemented by assembler instructions supported by processor(s) 602 or high-level languages, such as, for example, C, that can be compiled into such instructions. Operations associated with safety operations and configuration of safety operations not implemented in software may be implemented in hardware, e.g., via hardware accelerator 603.

The number, capability and/or capacity of these elements 602-665 may vary, depending on the number of other devices the device 600 is configured to support. Otherwise, the constitutions of elements 602-665 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

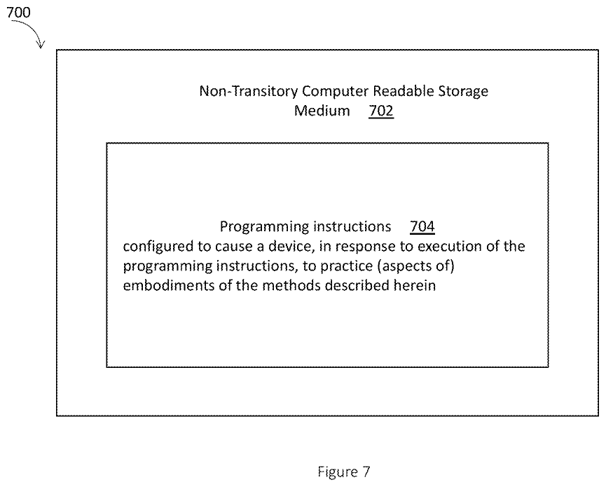

Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 702 may include a number of programming instructions 704. Programming instructions 704 may be configured to enable a device, e.g., device 600, in response to execution of the programming instructions, to perform, e.g., various operations associated with an apparatus including a CA/AD towing vehicle coupled with a trailer, as shown in FIG. 1 and FIG. 6.

In alternate embodiments, programming instructions 704 may be disposed on multiple computer-readable non-transitory storage media 702 instead. In alternate embodiments, programming instructions 704 may be disposed on computer-readable transitory storage media 702, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

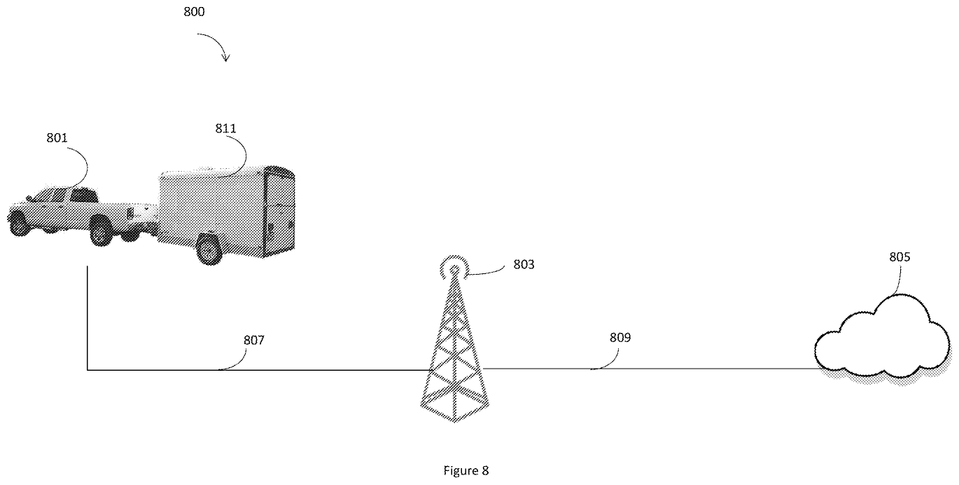

FIG. 8 illustrates an environment 800 in which various embodiments described with references to FIGS. 1-7 may be practiced. Environment 800 includes a CA/AD towing vehicle 801 coupled with a trailer 811, a wireless access node 803, and a cloud computing service 805 (also referred to as “cloud 805”, “the cloud 805”, and the like). The CA/AD towing vehicle 801 coupled with a trailer 811 may be an example of the apparatus 100 as illustrated in FIG. 1, and may include the OBU 120, the OBU 160, or the device 600 as shown in FIG. 6. For illustrative purposes, the following description may be applicable in a two dimensional (2D) freeway/highway/roadway environment. However, the embodiments described herein may also be applicable to any type of vehicle, such as trucks, buses, motorcycles, boats or motorboats, and/or any other motorized devices with a CA/AD towing vehicle coupled with a trailer, as illustrated in FIGS. 1-7.

The CA/AD towing vehicle 801 and the trailer 811 may be any type of motorized vehicle or device used for transportation of people or goods, which may be equipped with controls used for driving, parking, passenger comfort and/or safety, etc. The terms “motor”, “motorized”, etc., as used herein may refer to devices that convert one form of energy into mechanical energy, and may include internal combustion engines (ICE), compression combustion engines (CCE), electric motors, and hybrids (e.g., including an ICE/CCE and electric motor(s)).

The communications circuitry of the vehicle 801 may communicate with the cloud 805 via the wireless access node 803. The wireless access node 803 may be one or more hardware computer devices configured to provide wireless communication services to mobile devices within a coverage area or cell associated with the wireless access node 803. The wireless access node 803 may include a transmitter/receiver (or alternatively, a transceiver) connected to one or more antennas, one or more memory devices, one or more processors, one or more network interface controllers, and/or other like components. The one or more transmitters/receivers may be configured to transmit/receive data signals to/from one or more mobile devices via a link (e.g., link 807). Furthermore, one or more network interface controllers may be configured to transmit/receive with various network elements (e.g., one or more servers within a core network, etc.) over another backhaul connection (not shown). In embodiments, an OBU of the CA/AD towing vehicle 801 and an OBU of the trailer 811 may generate and transmit data to the wireless access node 803 over link 807, and the wireless access node 803 may provide the data to the cloud 805 over backhaul link 809. Additionally, during operation of the an OBU of the CA/AD towing vehicle 801 and an OBU of the trailer 811, the wireless access node 803 may obtain data intended for the OBU of the CA/AD towing vehicle 801 and the OBU of the trailer 811 from the cloud 805 over link 809, and may provide that data to the OBU of the CA/AD towing vehicle 801 and the OBU of the trailer 811 over link 807. The communications circuitry in the CA/AD towing vehicle 801 and the trailer 811 may communicate with the wireless access node 803 in accordance with one or more wireless communications protocols as discussed herein.

As an example, the wireless access node 803 may be a base station associated with a cellular network (e.g., an eNB in an LTE network, a gNB in a new radio access technology (NR) network, a WiMAX base station, etc.), an RSU, a remote radio head, a relay radio device, a smallcell base station (e.g., a femtocell, picocell, home evolved nodeB (HeNB), and the like), or other like network element. In embodiments where the wireless access node is a base station, the wireless access node 803 may be deployed outdoors to provide communications for the vehicle 801 when the vehicle 801 is operating at large, for example when deployed on public roads, streets, highways, etc.

In some embodiments, the wireless access node 803 may be a gateway (GW) device that may include one or more processors, communications systems (e.g., including network interface controllers, one or more transmitters/receivers connected to one or more antennas, and the like), and computer readable media. In such embodiments, the GW may be a wireless access point (WAP), a home/business server (with or without radio frequency (RF) communications circuitry), a router, a switch, a hub, a radio beacon, and/or any other like network device. In embodiments where the wireless access node 803 is a GW, the wireless access node 803 may be deployed in an indoor setting, such as a garage, factory, laboratory or testing facility, and may be used to provide communications for while parked, prior to sale on the open market, or otherwise not operating at large.

In embodiments, the cloud 805 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the cloud 805 may be associated with network operator who owns or controls equipment and other elements necessary to provide network-related services, such as one or more base stations or access points (e.g., wireless access node 803), one or more servers for routing digital data or telephone calls (for example, a core network or backbone network), etc. Implementations, components, and protocols used to communicate via such services may be those known in the art and are omitted herein for the sake of brevity.

In some embodiments, the cloud 805 may be a system of computer devices (e.g., servers, storage devices, applications, etc. within or associated with a data center or data warehouse) that provides access to a pool of computing resources. The term “computing resource” may refer to a physical or virtual component within a computing environment and/or within a particular computer device, such as memory space, processor time, electrical power, input/output operations, ports or network sockets, and the like. In these embodiments, the cloud 805 may be a private cloud, which offers cloud services to a single organization; a public cloud, which provides computing resources to the general public and shares computing resources across all customers/users; or a hybrid cloud or virtual private cloud, which uses a portion of resources to provide public cloud services while using other dedicated resources to provide private cloud services. For example, the hybrid cloud may include a private cloud service that also utilizes one or more public cloud services for certain applications or users, such as providing obtaining data from various data stores or data sources. In embodiments, a common cloud management platform (e.g., implemented as various virtual machines and applications hosted across the cloud 805 and database systems) may coordinate the delivery of data to the OBU of the CA/AD towing vehicle 801 and the OBU of the trailer 811. Implementations, components, and protocols used to communicate via such services may be those known in the art and are omitted herein for the sake of brevity.

Thus various example embodiments of the present disclosure have been described including, but are not limited to:

Example 1 may include an apparatus for computer assisted or autonomous driving (CA/AD), comprising: a trailer data collection unit to collect, from a trailer coupled with a CA/AD towing vehicle, trailer configuration data, including sensor configuration data for sensors disposed on the trailer; and an automation level determination unit, coupled with the trailer data collection unit, to determine a combined level of driving automation for the CA/AD towing vehicle and the trailer, based at least in part on the trailer configuration data, wherein the CA/AD towing vehicle alone has an initial level of driving automation.

Example 2 may include the apparatus of example 1 and/or some other examples herein, wherein the sensor configuration data include a number of sensors disposed on the trailer, and further include sensor types, sensor locations on the trailer, manufacturers of the sensors, resolutions of the sensors, ranges of the sensors, or data collection rates of the sensors.

Example 3 may include the apparatus of example 1 and/or some other examples herein, wherein the trailer configuration data further include a trailer length, a trailer width, a trailer height, a trailer wheel or axle distance measured from one end of the trailer, a trailer wheel or axle distance measured from another end of the trailer, a location of a coupler of the trailer, a trailer weight, a trailer shape, a trailer type, a trailer manufacturer, or a trailer capacity.

Example 4 may include the apparatus of any one of examples 1-3 and/or some other examples herein, wherein the CA/AD towing vehicle is a selected one of a commercial truck, a light duty car, a sport utility vehicle (SUV), a light vehicle, a heavy duty vehicle, a pickup truck, a van, a car, or a motorcycle.

Example 5 may include the apparatus of any one of examples 1-3 and/or some other examples herein, wherein the trailer includes a selected one of a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

Example 6 may include the apparatus of any one of examples 1-3 and/or some other examples herein, further comprising: a disablement unit coupled with the automation level determination unit to disable one or more automation driving features available to the initial level of driving automation but not to the combined level of driving automation.

Example 7 may include the apparatus of any one of examples 1-3 and/or some other examples herein, further comprising: a sensor interface coupled with the automation level determination unit to receive, from one or more sensors disposed on the CA/AD towing vehicle, sensor data that include identification information of the trailer; and an identification unit coupled to the sensor interface and the automation level determination unit to identify the trailer based on the sensor data having identification information of the trailer.

Example 8 may include the apparatus of example 7 and/or some other examples herein, wherein the sensor data further include one or more selected from radar data, ultrasonic sensor data, video sensor data, camera data, light detection and ranging (LiDAR) data, or global positioning system (GPS) data.

Example 9 may include the apparatus of any one of examples 1-3 and/or some other examples herein, further comprising: a blind spot elimination unit coupled with the automation level determination unit to provide information to place one or more sensors on the trailer or the CA/AD towing vehicle to eliminate a blind spot for the trailer or the CA/AD towing vehicle.

Example 10 may include the apparatus of any one of examples 1-3 and/or some other examples herein, further comprising: a driving path determination unit coupled with the automation level determination unit to determine a cornering path to be followed by the CA/AD towing vehicle coupled with the trailer to turn a corner, based at least in part on the trailer configuration data, configuration data for the CA/AD towing vehicle, and physical configuration of the corner.

Example 11 may include the apparatus of example 10 and/or some other examples herein, wherein the driving path determination unit is further to select a parking spot from a parking location with multiple parking spots, and to determine a parking path to park the CA/AD towing vehicle coupled with the trailer into the selected parking spot.

Example 12 may include the apparatus of any one of examples 1-3 and/or some other examples herein, further comprising: a communication interface to receive a request to tow the trailer by the CA/AD towing vehicle; an authentication unit coupled to the communication interface and the automation level determination unit to authenticate, via a communication technology, that the trailer is authorized to be towed by the CA/AD towing vehicle based at least in part on the request; and an engagement unit coupled with the automation level determination unit to couple a coupler of the CA/AD towing vehicle with a coupler of the trailer.

Example 13 may include the apparatus of example 12 and/or some other examples herein, wherein the communication technology includes a wireless technology selected from dedicated short range communications (DSRC) technology, Bluetooth technology, wireless fidelity (WiFi) technology, wireless local network (WLAN), cellular wireless network technology, wireless universal serial bus (WUSB) technology, or short range radio technology.

Example 14 may include the apparatus of example 12 and/or some other examples herein, wherein the coupler of the CA/AD towing vehicle includes a selected one of a ball and socket coupler, a gooseneck trailer jack, a straight coupler, an a-frame coupler, or an adjustable coupler.

Example 15 may include the apparatus of example 12 and/or some other examples herein, wherein the engagement unit is further to disengage the trailer from the CA/AD towing vehicle through disconnection of the coupler of the CA/AD towing vehicle from the coupler of the trailer.

Example 16 may include the apparatus of any one of examples 1-3 and/or some other examples herein, wherein the apparatus is a vehicle onboard unit (OBU) disposed in the CA/AD towing vehicle.

Example 17 may include the apparatus of example 16 and/or some other examples herein, wherein the apparatus is the CA/AD towing vehicle comprising the vehicle onboard unit (OBU).

Example 18 may include an apparatus for computer assisted or autonomous driving (CA/AD), comprising: a sensor configuration unit to collect sensor configuration data for one or more sensors disposed on a trailer; a trailer configuration unit to collect trailer configuration data; and a communication interface coupled with the sensor configuration unit and the trailer configuration unit to transmit the sensor configuration data and the trailer configuration data to a CA/AD towing vehicle.

Example 19 may include the apparatus of example 18 and/or some other examples herein, wherein the sensor configurations data include a number of sensors disposed on the trailer, and further include sensor types, sensor locations on the trailer, manufacturers of the sensors, resolutions of the sensors, ranges of the sensors, or data collection rates of the sensors.

Example 20 may include the apparatus of example 18 and/or some other examples herein, wherein the trailer configuration data include a trailer length, a trailer width, a trailer height, a trailer wheel or axle distance measured from one end of the trailer, a trailer wheel or axle distance measured from another end of the trailer, a location of the coupler of the trailer, a trailer weight, a trailer shape, a trailer type, a trailer manufacturer, or a trailer capacity.

Example 21 may include the apparatus of example 18 and/or some other examples herein, wherein the trailer includes one selected from a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer. Example 22 may include the apparatus of any one of examples 18-21 and/or some other examples herein, wherein the apparatus is a vehicle onboard unit (OBU) disposed in the trailer.

Example 23 may include the apparatus of example 22 and/or some other examples herein, wherein the apparatus is the trailer comprising the one or more sensors, and the vehicle onboard unit (OBU).

Example 24 may include one or more non-transitory computer-readable media comprising instructions that cause a computer assisted or autonomous driving (CA/AD) system in a CA/AD towing vehicle, in response to execution of the instructions by the CA/AD system, to: collect, from a trailer, sensor configuration data for one or more sensors disposed on the trailer, and trailer configuration data; and determine a combined level of driving automation for the CA/AD towing vehicle coupled to the trailer, wherein the CA/AD towing vehicle alone has an initial level of driving automation.

Example 25 may include the one or more non-transitory computer-readable media of example 24 and/or some other examples herein, wherein the CA/AD towing vehicle includes one selected from a commercial truck, a light duty car, a sport utility vehicle (SUV), a light vehicle, a heavy duty vehicle, a pickup truck, a van, a car, or a motorcycle.

Example 26 may include a method for computer assisted or autonomous driving (CA/AD), comprising: collecting, from a trailer coupled with a CA/AD towing vehicle, trailer configuration data, including sensor configuration data for sensors disposed on the trailer; and determining a combined level of driving automation for the CA/AD towing vehicle and the trailer, based at least in part on the trailer configuration data, wherein the CA/AD towing vehicle alone has an initial level of driving automation.

Example 27 may include the method of example 26 and/or some other examples herein, further comprising: disabling one or more automation driving features available to the initial level of driving automation but not to the combined level of driving automation.

Example 28 may include the method of example 26 and/or some other examples herein, further comprising: receiving, from one or more sensors disposed on the CA/AD towing vehicle, sensor data that include identification information of the trailer; and identifying the trailer based on the sensor data having identification information of the trailer.

Example 29 may include the method of example 26 and/or some other examples herein, further comprising: determining a cornering path to be followed by the CA/AD towing vehicle coupled with the trailer to turn a corner, based at least in part on the trailer configuration data, configuration data for the CA/AD towing vehicle, and physical configuration of the corner.

Example 30 may include the method of example 26 and/or some other examples herein, further comprising: receiving a request to tow the trailer by the CA/AD towing vehicle; authenticating, via a communication technology, that the trailer is authorized to be towed by the CA/AD towing vehicle based at least in part on the request; and coupling a coupler of the CA/AD towing vehicle with a coupler of the trailer.

Example 31 may include the method of any one of examples 26-30 and/or some other examples herein, wherein the sensor configuration data include a number of sensors disposed on the trailer, and further include sensor types, sensor locations on the trailer, manufacturers of the sensors, resolutions of the sensors, ranges of the sensors, or data collection rates of the sensors.

Example 32 may include the method of any one of examples 26-30 and/or some other examples herein, wherein the trailer configuration data further include a trailer length, a trailer width, a trailer height, a trailer wheel or axle distance measured from one end of the trailer, a trailer wheel or axle distance measured from another end of the trailer, a location of a coupler of the trailer, a trailer weight, a trailer shape, a trailer type, a trailer manufacturer, or a trailer capacity.

Example 33 may include the method of any one of examples 26-30 and/or some other examples herein, wherein the CA/AD towing vehicle is a selected one of a commercial truck, a light duty car, a sport utility vehicle (SUV), a light vehicle, a heavy duty vehicle, a pickup truck, a van, a car, or a motorcycle.

Example 34 may include the method of any one of examples 26-30 and/or some other examples herein, wherein the trailer includes a selected one of a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

Example 35 may include an apparatus for computer assisted or autonomous driving (CA/AD), comprising: means for collecting, from a trailer coupled with a CA/AD towing vehicle, trailer configuration data, including sensor configuration data for sensors disposed on the trailer; and means for determining a combined level of driving automation for the CA/AD towing vehicle and the trailer, based at least in part on the trailer configuration data, wherein the CA/AD towing vehicle alone has an initial level of driving automation.

Example 36 may include the apparatus of example 35 and/or some other examples herein, further comprising: means for disabling one or more automation driving features available to the initial level of driving automation but not to the combined level of driving automation.

Example 37 may include the apparatus of example 35 and/or some other examples herein, further comprising: means for receiving, from one or more sensors disposed on the CA/AD towing vehicle, sensor data that include identification information of the trailer; and means for identifying the trailer based on the sensor data having identification information of the trailer.

Example 38 may include the apparatus of example 35 and/or some other examples herein, further comprising: means for determining a cornering path to be followed by the CA/AD towing vehicle coupled with the trailer to turn a corner, based at least in part on the trailer configuration data, configuration data for the CA/AD towing vehicle, and physical configuration of the corner.

Example 39 may include the apparatus of example 35 and/or some other examples herein, further comprising: means for receiving a request to tow the trailer by the CA/AD towing vehicle; means for authenticating, via a communication technology, that the trailer is authorized to be towed by the CA/AD towing vehicle based at least in part on the request; and means for coupling a coupler of the CA/AD towing vehicle with a coupler of the trailer.

Example 40 may include the apparatus of any one of examples 35-39 and/or some other examples herein, wherein the sensor configuration data include a number of sensors disposed on the trailer, and further include sensor types, sensor locations on the trailer, manufacturers of the sensors, resolutions of the sensors, ranges of the sensors, or data collection rates of the sensors.

Example 41 may include the apparatus of any one of examples 35-39 and/or some other examples herein, wherein the trailer configuration data further include a trailer length, a trailer width, a trailer height, a trailer wheel or axle distance measured from one end of the trailer, a trailer wheel or axle distance measured from another end of the trailer, a location of a coupler of the trailer, a trailer weight, a trailer shape, a trailer type, a trailer manufacturer, or a trailer capacity.

Example 42 may include the apparatus of any one of examples 35-39 and/or some other examples herein, wherein the CA/AD towing vehicle is a selected one of a commercial truck, a light duty car, a sport utility vehicle (SUV), a light vehicle, a heavy duty vehicle, a pickup truck, a van, a car, or a motorcycle.

Example 43 may include the apparatus of any one of examples 35-39 and/or some other examples herein, wherein the trailer includes a selected one of a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

Although certain embodiments have been illustrated and described herein for purposes of description this application is intended to cover any adaptations or variations of the embodiments discussed herein. Therefore, it is manifestly intended that embodiments described herein be limited only by the claims.

What is claimed is:

1. An apparatus for computer assisted or autonomous driving (CA/AD), comprising:
a trailer data collection unit to collect, from a trailer coupled with a CA/AD towing vehicle, trailer configuration data, including sensor configuration data for sensors disposed on the trailer; and
an automation level determination unit, coupled with the trailer data collection unit, to determine a combined level of driving automation for the CA/AD towing vehicle and the trailer, based at least in part on the trailer configuration data, wherein the CA/AD towing vehicle alone has an initial level of driving automation.

2. The apparatus of claim 1, wherein the sensor configuration data include a number of sensors disposed on the trailer, and further include sensor types, sensor locations on the trailer, manufacturers of the sensors, resolutions of the sensors, ranges of the sensors, or data collection rates of the sensors.

3. The apparatus of claim 1, wherein the trailer configuration data further include a trailer length, a trailer width, a trailer height, a trailer wheel or axle distance measured from one end of the trailer, a trailer wheel or axle distance measured from another end of the trailer, a location of a coupler of the trailer, a trailer weight, a trailer shape, a trailer type, a trailer manufacturer, or a trailer capacity.

4. The apparatus of claim 1, wherein the CA/AD towing vehicle is a selected one of a commercial truck, a light duty car, a sport utility vehicle (SUV), a light vehicle, a heavy duty vehicle, a pickup truck, a van, a car, or a motorcycle.

5. The apparatus of claim 1, wherein the trailer includes a selected one of a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

6. The apparatus of claim 1, further comprising:
a disablement unit coupled with the automation level determination unit to disable one or more automation driving features available to the initial level of driving automation but not to the combined level of driving automation.

7. The apparatus of claim 1, further comprising:
a sensor interface coupled with the automation level determination unit to receive, from one or more sensors disposed on the CA/AD towing vehicle, sensor data that include identification information of the trailer; and
an identification unit coupled to the sensor interface and the automation level determination unit to identify the trailer based on the sensor data having identification information of the trailer.

8. The apparatus of claim 7, wherein the sensor data further include one or more selected from radar data, ultrasonic sensor data, video sensor data, camera data, light detection and ranging (LiDAR) data, or global positioning system (GPS) data.

9. The apparatus of claim 1, further comprising:
a blind spot elimination unit coupled with the automation level determination unit to provide information to place one or more sensors on the trailer or the CA/AD towing vehicle to eliminate a blind spot for the trailer or the CA/AD towing vehicle.

10. The apparatus of claim 1, further comprising:
a driving path determination unit coupled with the automation level determination unit to determine a cornering path to be followed by the CA/AD towing vehicle coupled with the trailer to turn a corner, based at least in part on the trailer configuration data, configuration data for the CA/AD towing vehicle, and physical configuration of the corner.

11. The apparatus of claim 10, wherein the driving path determination unit is further to select a parking spot from a parking location with multiple parking spots, and to determine a parking path to park the CA/AD towing vehicle coupled with the trailer into the selected parking spot.

12. The apparatus of claim 1, further comprising:
a communication interface to receive a request to tow the trailer by the CA/AD towing vehicle;
an authentication unit coupled to the communication interface and the automation level determination unit to authenticate, via a communication technology, that the trailer is authorized to be towed by the CA/AD towing vehicle based at least in part on the request; and
an engagement unit coupled with the automation level determination unit to couple a coupler of the CA/AD towing vehicle with a coupler of the trailer.

13. The apparatus of claim 12, wherein the communication technology includes a wireless technology selected from dedicated short range communications (DSRC) technology, Bluetooth technology, wireless fidelity (WiFi) technology, wireless local network (WLAN), cellular wireless network technology, wireless universal serial bus (WUSB) technology, or short range radio technology.

14. The apparatus of claim 12, wherein the coupler of the CA/AD towing vehicle includes a selected one of a ball and socket coupler, a gooseneck trailer jack, a straight coupler, an a-frame coupler, or an adjustable coupler.

15. The apparatus of claim 12, wherein the engagement unit is further to disengage the trailer from the CA/AD towing vehicle through disconnection of the coupler of the CA/AD towing vehicle from the coupler of the trailer.

16. The apparatus of claim 1, wherein the apparatus is a vehicle onboard unit (OBU) disposed in the CA/AD towing vehicle.

17. The apparatus of claim 16, wherein the apparatus is the CA/AD towing vehicle comprising the vehicle onboard unit (OBU).

18. An apparatus for computer assisted or autonomous driving (CA/AD), comprising:
a sensor configuration unit to collect sensor configuration data for one or more sensors disposed on a trailer;
a trailer configuration unit to collect trailer configuration data;
a communication interface coupled with the sensor configuration unit and the trailer configuration unit to transmit the sensor configuration data and the trailer configuration data to a CA/AD towing vehicle.

19. The apparatus of claim 18, wherein the sensor configurations data include a number of sensors disposed on the trailer, and further include sensor types, sensor locations on the trailer, manufacturers of the sensors, resolutions of the sensors, ranges of the sensors, or data collection rates of the sensors.

20. The apparatus of claim 18, wherein the trailer configuration data include a trailer length, a trailer width, a trailer height, a trailer wheel or axle distance measured from one end of the trailer, a trailer wheel or axle distance measured from another end of the trailer, a location of the coupler of the trailer, a trailer weight, a trailer shape, a trailer type, a trailer manufacturer, or a trailer capacity.

21. The apparatus of claim 18, wherein the trailer includes one selected from a boat, an all-terrain vehicle, a general purpose trailer, a mobile home, a motorcycle trailer, a bicycle trailer, a utility trailer, a travel trailer, a camper, a genset trailer, a pusher trailer, a semi-trailer, or a full trailer.

22. The apparatus of claim 18, wherein the apparatus is a vehicle onboard unit (OBU) disposed in the trailer.

23. The apparatus of claim 22, wherein the apparatus is the trailer comprising the one or more sensors, and the vehicle onboard unit (OBU).

24. One or more non-transitory computer-readable media comprising instructions that cause a computer assisted or autonomous driving (CA/AD) system in a CA/AD towing vehicle, in response to execution of the instructions by the CA/AD system, to:
collect, from a trailer, sensor configuration data for one or more sensors disposed on the trailer, and trailer configuration data; and
determine a combined level of driving automation for the CA/AD towing vehicle coupled to the trailer, wherein the CA/AD towing vehicle alone has an initial level of driving automation.

25. The one or more non-transitory computer-readable media of claim 24, wherein the CA/AD towing vehicle includes one selected from a commercial truck, a light duty car, a sport utility vehicle (SUV), a light vehicle, a heavy duty vehicle, a pickup truck, a van, a car, or a motorcycle.
